(19) United States
(12) Patent Application Publication
(10) Pub. No.: US 2018/0262018 A1
(43) Pub. Date: Sep. 13, 2018

(54) POWER SUPPLY DEVICE, METHOD OF CONTROLLING POWER SUPPLY DEVICE, AND STORAGE MEDIUM STORING POWER SUPPLY DEVICE CONTROL PROGRAM

(71) Applicant: Panasonic Intellectual Property Management Co., Ltd., Osaka (JP)

(72) Inventors: Nobuaki SATOH, Kanagawa (JP); Satoshi KOMINAMI, Kanagawa (JP)

(21) Appl. No.: 15/980,146

(22) Filed: May 15, 2018

Related U.S. Application Data
(63) Continuation of application No. PCT/JP2016/004975, filed on Nov. 28, 2016.

(30) Foreign Application Priority Data
Nov. 30, 2015 (JP) 2015-233824

(51) Int. Cl. H02J 7/00; H02J 7/02; H02J 7/04

(52) U.S. Cl. CPC H02J 7/007; H02J 7/042; H02J 7/022

(57) ABSTRACT

A power supply device includes a plurality of power converters connected in parallel to each other and each configured to output power to a load after converting voltage of input power into output voltage, and a controller configured to change a number of one or more power converters to be put into operation out of the plurality of power converters based on total output power to the load. The controller changes timing of changing the number of the one or more power converters to be put into operation depending on the load regulation of the load.

### CROSS-REFERENCE TO RELATED APPLICATIONS

This application is a continuation of the PCT International Application No. PCT/JP2016/004975 filed on Nov. 28, 2016, which claims the benefit of foreign priority of Japanese patent application No. 2015-233824 filed on Nov. 30, 2015, the contents all of which are incorporated herein by reference.

### BACKGROUND

### 1. Technical Field

The present disclosure relates to a power supply device, a method of controlling the power supply device, and a storage medium storing a power supply device control program.

### 2. Description of the Related Art

Japanese Unexamined Application Publications No. 4-33522 and No.2003-199201 disclose power supply devices that include a plurality of parallel-connected power converters for converting the input power from a power supply in the voltage and sending to a load. The power supply devices change the number of the power converters to be put into operation depending on the magnitude of the load.

### SUMMARY

The power supply device according to an aspect of the present disclosure includes a plurality of power converters connected in parallel to each other and each configured to output power to a load after converting voltage of input power into output voltage. The power supply device further includes a controller configured to change a number of one or more power converters to be put into operation out of the plurality of power converters based on total output power to the load. The controller changes timing of changing the number of one or more power converters to be put into operation depending on the load regulation of the load.

The method of controlling the power supply device according to an aspect of the present disclosure is a method of controlling the power supply device including a plurality of power converters connected in parallel to each other and each configured to output power to a load after converting voltage of input power into output voltage. The method a step of changing a number of one or more power converters to be put into operation out of the plurality of power converters based on total output power to the load, and a step of changing timing of changing the number of the one or more power converters to be put into operation depending on the load regulation of the load.

The power supply device control program or the non-transitory computer readable medium according to an aspect of the present disclosure enables a computer of a power supply device to implement following processes. The power supply device includes a plurality of power converters connected in parallel to each other and each configured to output power to a load after converting voltage of input power into output voltage. In one of the processes, a number of one or more power converters to be put into operation out of the plurality of power converters is changed based on total output power to the load. In another one of the processes, timing of changing the number of the one or more power converters to be put into operation is changed depending on the load regulation of the load.

The present disclosure achieves high efficiency at low load, and yet prevents overload at the time of sudden load-up.

### BRIEF DESCRIPTION OF DRAWINGS

FIG. 1A is a graph showing an example of switching from a single operation to a parallel operation due to load regulation according to a power supply device known in the art.

FIG. 1B is a graph showing another example of switching from the single operation to the parallel operation due to load regulation according to the power supply device known in the art.

FIG. 2 is a block diagram showing a configuration example of a power supply device according to an embodiment of the present disclosure.

FIG. 3 is a flowchart showing an operation example of a DSP of the power supply device according to the embodiment of the present disclosure.

FIG. 4 is a graph showing an example of load regulation according to the embodiment of the present disclosure.

FIG. 5 is a block diagram showing a configuration example of a power supply device according to a modified example of the present disclosure.

### DETAILED DESCRIPTION OF PREFERRED EMBODIMENTS

Conventional problems will be described prior to describing an embodiment of the present disclosure. The above-described power supply device allows only one power converter to operate in the case of low load so as to achieve high efficiency. However, if there is a sudden load-up (e.g., an increase in the power consumption of an auxiliary device which is power-supplied from the power converter), it may cause overload. Overload can prevent proper operation of devices that are power-supplied from the power converters.

It is an object of the present disclosure to provide a power supply device that achieves high efficiency at low load, and yet prevents overload at the time of sudden load-up. It is another object of the present disclosure to provide a method of controlling the power supply device and a power supply device control program (or a non-transitory computer readable medium).

### Findings on which the Present Disclosure is Based

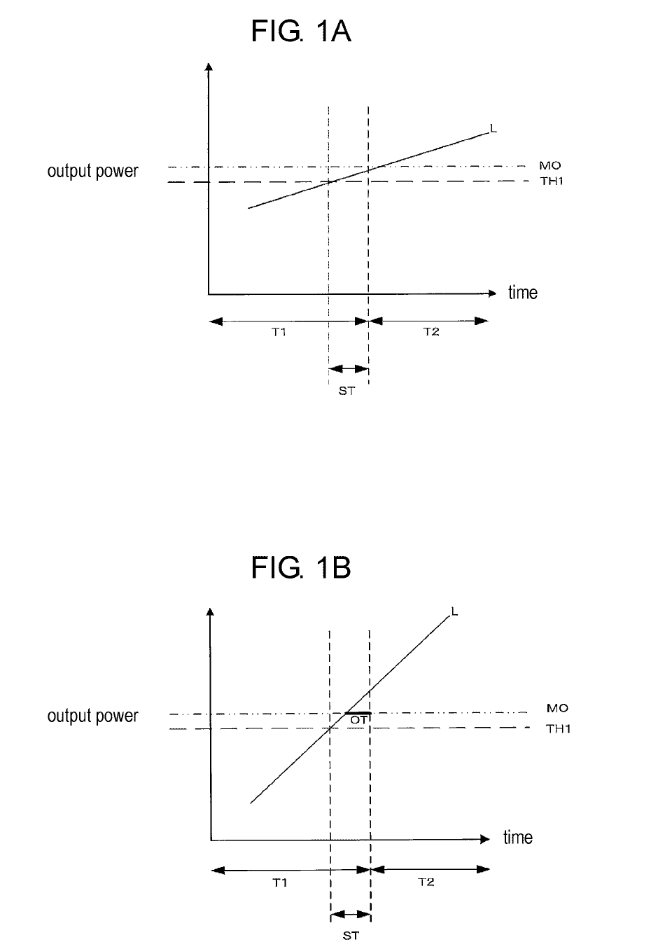

Findings on which the present disclosure is based will now be described with reference to FIGS. 1A and 1B. FIGS. 1A and 1B are graphs showing examples of switching from a single operation to a parallel operation due to load regulation (load-up) in power supply devices known in the art each including two power converters. FIG. 1B shows a case in which load regulation in a predetermined period of time (hereinafter, simply referred to as “load regulation”) is higher (i.e., steeper) than in FIG. 1A. The load regulation is given by the slope of a straight line L in each of FIGS. 1A and 1B.

In FIGS. 1A and 1B, the horizontal axis represents time, and the vertical axis represents the output power of the power converters (i.e., the magnitude of the load). In FIGS. 1A and 1B, T1 represents the time during which one power converter alone operates (hereinafter, single operation time), T2 represents the time during which two power converters operate concurrently (hereinafter, parallel operation time), ST represents the time (hereinafter, switchover time) required to switch from the single operation where one power converter alone operates to the parallel operation where two power converters operate concurrently. Further in FIGS. 1A and 1B, MO represents maximum output power obtained when one power converter alone operates, and TH1 represent a threshold (also referred to as switching threshold or power threshold for changing the number of DC/DC converter(s)) for switching from the single operation to the parallel operation.

As shown in FIGS. 1A and 1B, when the output power of one power converter exceeds the threshold TH1, the single operation is switched to the parallel operation. In order to achieve high efficiency at low load, the single operation time T1 is preferably as long as possible. For this reason, the threshold TH1 is preferably set close to the maximum output power MO.

When load regulation is low as shown in FIG. 1A (e.g., an auxiliary device, which is power-supplied as an example of the load from the power converter, has a low power consumption), the parallel operation is started before the load regulation reaches the maximum output power MO. However, when the load regulation is high as shown in FIG. 1B (e.g., an auxiliary device which is power-supplied from the power converter has a high power consumption), the load regulation exceeds the maximum output power MO before the parallel operation is started, thereby causing overload. Overload can, for example, prevent proper operation of auxiliary devices which are power-supplied from power converters. In FIG. 1B, OT represents the time when an overload is generated.

Thus, in power supply devices known in the art, a sudden load-up during the single operation can cause overload.

To solve the problems, it is an object of the present disclosure to achieve high efficiency at low load, and yet prevents overload at the time of sudden load-up.

### Exemplary Embodiment

An embodiment of the present disclosure will now be described with reference to drawings.

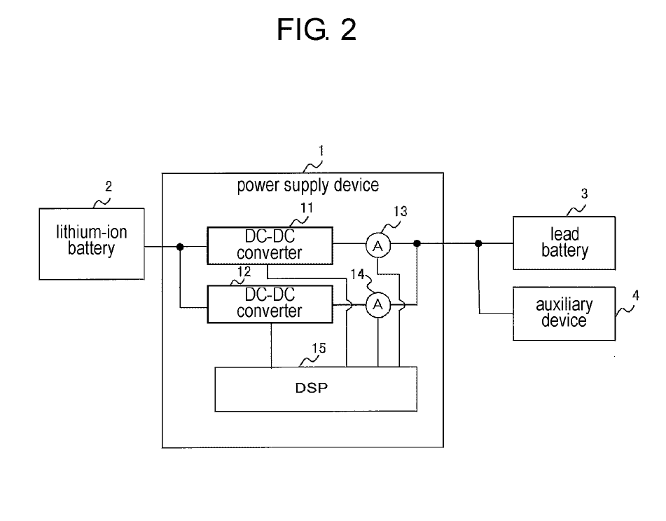

First, a configuration example of power supply device 1 according to the present exemplary embodiment will be described with reference to FIG. 2. FIG. 2 is a block diagram showing an example configuration of power supply device 1 according to the present exemplary embodiment.

Power supply device 1, lithium-ion battery 2, lead battery 3, and auxiliary device 4 shown in FIG. 2 can be mounted, for example, to a hybrid electric vehicle (HEV).

First, lithium-ion battery 2, lead battery 3, and auxiliary device 4 will be described as follows.

Lithium-ion battery 2 is electrically connected to power supply device 1 and supplies power to power supply device 1. Lithium-ion battery 2 has a voltage of about 400 V.

Lead battery 3 is electrically connected to power supply device 1 and is charged with power reduced in voltage by power supply device 1. The power charged to lead battery 3 can be used to start the engine or to operate auxiliary device 4. In FIG. 2, lead battery 3 is illustrated as a different component from auxiliary device 4, but may be referred to as an auxiliary device.

Auxiliary device 4 (an example of a load) is electrically connected to power supply device 1 and lead battery 3, and is operated with the power reduced in voltage by power supply device 1. Specific examples of auxiliary device 4 include windshield wipers, power windows, electric power steering systems, car navigation systems, audio devices, air conditioners, lighting systems, brake actuators, defoggers, and antilock brake systems (ABS). FIG. 2 shows only one auxiliary device 4; however, two or more auxiliary devices 4 may be provided. Furthermore, auxiliary device 4 can be operated by the power supplied from lead battery 3.

This has been the description of lithium-ion battery 2, lead battery 3, and auxiliary device 4.

Next, power supply device 1 will now be described.

Power supply device 1 is electrically connected to lithium-ion battery 2, lead battery 3, and auxiliary device 4. As shown in FIG. 2, power supply device 1 includes DC-DC converters 11 and 12, ammeters 13 and 14, and digital signal processor (DSP) 15.

DC-DC converters 11 and 12 (examples of the power converters) are connected in parallel to each other and reduce the voltage of the power received from lithium-ion battery 2 to, for example, around 12 V, and send the converted power to lead battery 3.

DC-DC converters 11 and 12 are electrically connected to DSP 15, and performs voltage reduction based on control signals received from DSP 15, respectively. When no control signal comes from DSP 15, DC-DC converters 11 and 12 are placed in the OFF state.

Ammeter 13 measures the output current of DC-DC converter 11 and sends a signal indicating the measured output current to DSP 15.

Ammeter 14 measures the output current of DC-DC converter 12 and sends a signal indicating the measured output current to DSP 15. To simplify explanation, ammeters 13 and 14 are located outside DC-DC converters 11 and 12 in FIG. 2, but may alternatively be included in DC-DC converters 11 and 12, respectively.

DSP 15 (an example of a controller) sends the above-mentioned control signals to DC-DC converters 11 and 12 so as to change the number of one or two DC-DC converters to be put into operation out of DC-DC converters 11 and 12. This process is hereinafter referred to as a switching process (an example of a changing process).

For example, DSP 15 sends the control signal to DC-DC converter 11 but not to DC-DC converter 12, thus putting DC-DC converter 11 alone into operation (an example of a single operation).

Alternatively, DSP 15 sends the control signals to DC-DC converters 11 and 12, respectively, thus putting both of DC-DC converters 11 and 12 into operation (an example of a parallel operation).

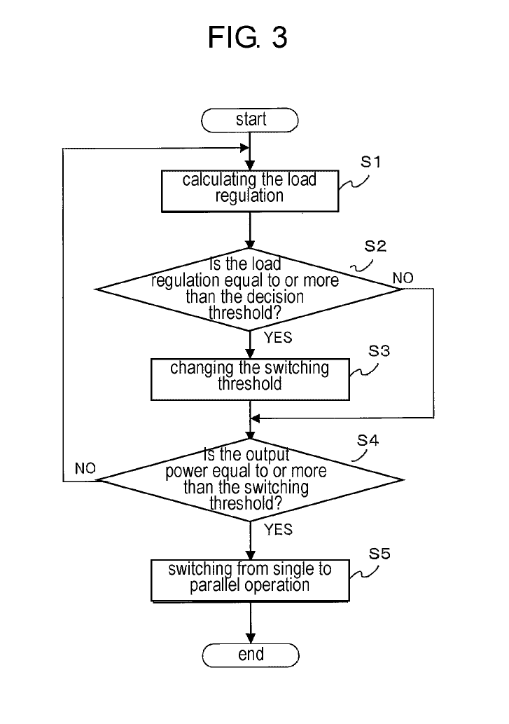

A specific example of the procedure performed by DSP 15 including the above-mentioned switching process will be described later with reference to the flowchart of FIG. 3.

This has been the description of power supply device 1.

Next, an operational example of DSP 15 of power supply device 1 will be described with reference to FIG. 3. FIG. 3 is a flowchart showing an operation example of DSP 15. In the following description, the procedure shown in FIG. 3 is performed while DC-DC converter 11 alone is in operation.

First, DSP 15 receives the signal indicating the output current of DC-DC converter 11 from ammeter 13, and calculates the load regulation of auxiliary device 4 based on the output current (Step S1). This calculation can be performed by, for example, time differentiation. In the case of parallel operation, DSP 15 receives the signals each indicating the output current from each of ammeters 13 and 14, and calculate the load regulation based on the output currents of DC-DC converters 11 and 12.

Next, DSP 15 determines whether or not the calculated load regulation is equal to or more than a predetermined decision threshold (Step S2).

The decision threshold is predetermined based on a predetermined switchover time (the time required to switch from the single operation to the parallel operation) and a predetermined maximum output power of DC-DC converter 11. The decision threshold can be, for example, a load regulation having a slope that does not exceed the maximum output power of DC-DC converter 11 at the end of the switchover time (i.e., at the start of parallel operation). The slope is, in other words, the slope below which no overload occurs during the switchover time.

As a result of decision in Step S2, if the calculated load regulation is less than the decision threshold (Step S2: NO), the process goes to Step S4, which will be described later.

On the other hand, if the calculated load regulation is equal to or more than the decision threshold (Step S2: YES), DSP 15 changes the predetermined switching threshold to a smaller value (Step S3). By changing the switching threshold in this manner, DSP 15 changes the timing of changing the number of one or two DC-DC converters to be put into operation out of DC-DC converters 11 and 12.

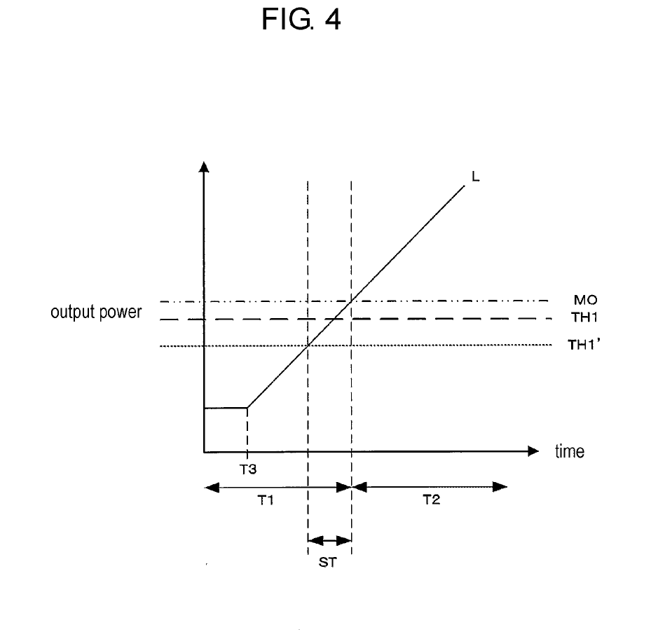

The switching threshold is a power threshold for switching from the single operation to the parallel operation. An example of the switching threshold is shown in FIG. 4. In FIG. 4, T1 represents the single operation time, T2 represents the parallel operation time, and ST represents the switchover time as in FIGS. 1A and 1B. The load regulation (given by the slope of the straight line L) shown in FIG. 4 is identical to the load regulation shown in FIG. 1B.

As shown in FIG. 4, the switching threshold TH1, which has not yet been changed, is set, for example, close to and below the maximum output power MO of DC-DC converter 11. If there occurs a sudden load-up due to an increase in the power consumption of auxiliary device 4 at timing T3 shown in FIG. 4, the load regulation is determined to be equal to or more than the decision threshold (i.e., steep) at a predetermined timing after the timing T3 and before the switchover time ST. Consequently, the switching threshold TH1 is changed to a predetermined switching threshold TH1′ in Step S3. This change leads to changing the timing of changing how many DC-DC converter(s) to be put into operation out of DC-DC converters 11 and 12.

Next, DSP 15 determined whether or not the output power of DC-DC converter 11 is equal to or more than the switching threshold (Step S4). The switching threshold in this case is the switching threshold TH1 if it has not gone through the process of Step S3, and is the switching threshold TH1′ if it has gone through the process of Step S3.

As a result in Step S4, if the output power of DC-DC converter 11 is less than the switching threshold (Step S4: NO), the process goes back to Step Sl.

On the other hand, if the output power of DC-DC converter 11 is equal to or more than the switching threshold (Step S4: YES), DSP 15 switches the single operation to the parallel operation (Step S5). To be more specific, DSP 15 sends the control signal to DC-DC converter 12.

As a result, as shown in FIG. 4, switching from the single operation to the parallel operation is started when the output power of DC-DC converter 11 exceeds the switching threshold TH1′, and the switching to parallel operation is completed when the output power of DC-DC converters 11 and 12 reaches the maximum output power MO.

This has been the description of an operational example of DSP 15 of power supply device 1.

As described so far, when the load regulation is less than the decision threshold, power supply device 1 according to the exemplary embodiment achieves high efficiency at low load by using the switching threshold that has not yet been changed. Meanwhile, when the load regulation is equal to or more than the decision threshold, overload at the time of sudden load-up can be prevented by changing the timing of changing how many DC-DC converter(s) to be put into operation out of DC-DC converters 11 and 12.

An embodiment of the present disclosure has been described so far, but the present disclosure is not limited to this exemplary embodiment and can be varied variously. Modified examples will now be described as follows.

### Modified Example 1

In the exemplary embodiment, the timing of changing the number of DC-DC converter(s) to be put into operation out of DC-DC converters 11 and 12 is changed by changing the switching threshold. However, this is not the only way to change the timing. An alternative approach is as follows: firstly, to prepare a table where load regulation to be obtained by calculation is associated with the timing of changing the number of DC-DC converter(s) to be put into operation out of DC-DC converters 11 and 12; secondly, to make DSP 15 refer to the table so as to change the timing as associated with the calculated load regulation.

### Modified Example 2

In the configuration shown in FIG. 2, lithium-ion battery 2 may be replaced, for example, by a household AC power supply. In this case, parallel-connected two AC-DC converters may be provided at the previous stage of DC-DC converters 11 and 12 (between the AC power supply and DC-DC converters 11 and 12).

### Modified Example 3

In the configuration shown in FIG. 2, DC-DC converters 11 and 12 may be replaced, for example, by parallel-connected two AC-DC converters.

### Modified Example 4

In the exemplary embodiment, the switching threshold is changed when the load regulation calculated by DSP 15 is equal to or more than the decision threshold. However, this is not the only way to change the threshold.

An alternative approach is as follows: firstly, to prepare a table where load regulation to be obtained by calculation is associated with the changed switching threshold; secondly to make DSP 15 refer to the table so as to change the switching threshold as associated with the calculated load regulation. In this case, all the changed switching thresholds shown in the table are smaller than the switching thresholds that have not yet been changed.

Still alternatively, DSP 15 may set a switching threshold depending on the calculated load regulation and a predetermined switchover time. In this case, if the calculated load regulation is larger than the previously calculated load regulation, the calculated switching threshold is smaller than the previously set value.

### Modified Example 5

DSP 15 may calculate the load regulation based not on the output voltage of DC-DC converter 11, but on the output current of DC-DC converter 11.

### Modified Example 6

DSP 15 may receive from auxiliary device 4 information on the operation conditions of auxiliary device 4 (e.g., whether in operation or not) and calculate the load regulation based on the information. This makes it faster to calculate the load regulation than in the case of calculating it based on the output current of DC-DC converters 11 and 12, thus making it faster to change the switching threshold.

### Modified Example 7

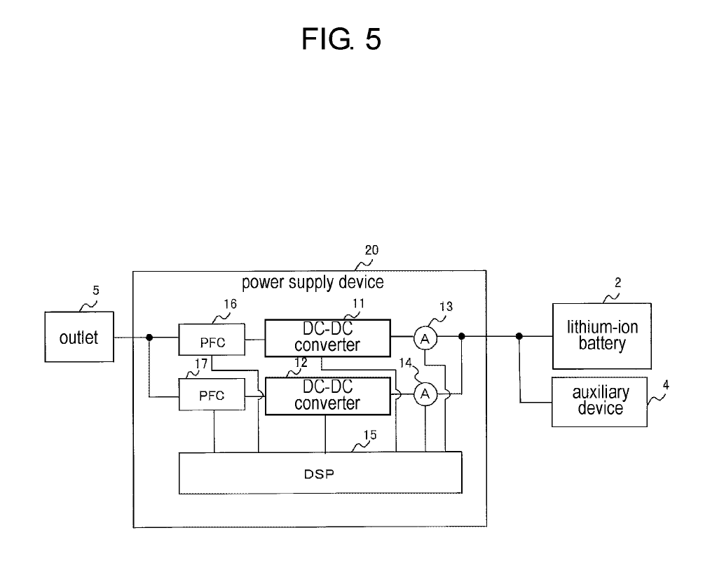

In the exemplary embodiment, power supply device 1 is mounted to a hybrid electric vehicle (HEV), but this is not the only option available. Power supply device 20, which can be mounted to either an electric vehicle (EV) or a plug-in hybrid vehicle (PHV), will be described as follows with reference to FIG. 5. In FIG. 5, like components are labeled with same reference numerals with respect to FIG. 2, and the description thereof will be omitted.

As shown in FIG. 5, power supply device 20 is connected to household outlet 5. Power supply device 20 includes parallel-connected power factor corrections (PFC) 16 and 17, in addition to the components shown in FIG. 2. PFC 16 is electrically connected to outlet 5, DC-DC converter 11, and DSP 15. PFC 17 is electrically connected to outlet 5, DC-DC converter 12, and DSP 15. PFCs 16 and 17 convert AC voltage of outlet 5 into DC voltage.

DSP 15 of power supply device 20 performs the processes shown in FIG. 3 described in the exemplary embodiment. Consequently, the present modified example provides similar operation and effects to those of the exemplary embodiment.

This has been the description of the modified examples. These modified examples may be combined appropriately

Thus, the embodiment and modified examples of the present disclosure have been so far described in detail with reference to drawings. The above-described functions of power supply device 1 can also be implemented by a computer program. The functions of power supply device 1 can be implemented, for example, by making DSP 15 copy the program stored in a predetermined storage device (not shown) to random access memory (RAM) (not shown) and then making DSP 15 sequentially read instructions contained in the program from the RAM and implement the instructions. In implementing the program, the information obtained in the various processes described in the exemplary embodiment and modified examples are stored in RAM or the storage device and are used appropriately.

The present disclosure is useful as a power supply device mounted on a vehicle, a method of controlling the power supply device, and a power supply device control program (or a non-transitory computer readable medium).

What is claimed is:

1. A power supply device comprising:
a plurality of power converters connected in parallel to each other and each configured to output power to a load after converting voltage of input power into output voltage; and
a controller configured to change a number of one or more power converters to be put into operation out of the plurality of power converters based on total output power to the load,
wherein the controller changes timing of changing the number of one or more power converters to be put into operation depending on load regulation of the load.

2. The power supply device according to claim 1,
wherein the controller changes the number of the one or more power converters to be put into operation based on the total output power to the load and a power threshold for changing the number of the one or more power converters to be put into operation, and
the controller changes the timing of changing the number of the one or more power converters to be put into operation by changing the power threshold depending on the load regulation of the load.

3. The power supply device according to claim 1,
wherein the load is an auxiliary device including at least a lead battery, and
each of the plurality of power converters are DC-DC converters is configured to output power to the lead battery after converting voltage of input power from a lithium-ion battery into output voltage.

4. The power supply device according to claim 2,
wherein the controller changes the power threshold to a smaller value when the load regulation is equal to or more than a decision threshold.

5. The power supply device according to claim 2,
wherein the controller sets the power threshold depending on the load regulation and a time required to change the number of the one or more power converters to be put into operation.

6. The power supply device according to claim 1,
wherein the controller calculates the load regulation based on total output current of one or more active power converters out of the plurality of power converters.

7. The power supply device according to claim 3,
wherein the controller:
receives information on an operation condition of the auxiliary device from the auxiliary device, and
calculates the load regulation based on the information.

8. A method of controlling a power supply device, the power supply device comprising a plurality of power converters connected in parallel to each other and each configured to output power to a load after converting voltage of input power into output voltage,
the method comprising:
changing a number of one or more power converters to be put into operation out of the plurality of power converters based on total output power to the load; and
changing timing of changing the number of the one or more power converters to be put into operation depending on load regulation of the load.

9. A storage medium storing a power supply device control program to be executed by a computer of a power supply device, and the storage medium being a non-transitory storage medium,
the power supply device comprising a plurality of power converters connected in parallel to each other and each configured to output power to a load after converting voltage of input power into output voltage,
wherein the power supply device control program causes the computer to execute
a process of changing a number of one or more power converters to be put into operation out of the plurality of power converters based on total output power to the load,
a process of changing timing of changing the number of the one or more power converters to be put into operation out depending on load regulation of the load.
